(19) United States
(12) Patent Application Publication
(10) Pub. No.: US 2004/0128548 A1
(43) Pub. Date: Jul. 1, 2004

(54) Generic communication server engine

(75) Inventors: Bobby S. Basha, Bangalore (IN); Rashmy Bharadawaj, Bangalore (IN); Karthik Hrishikesh, Trivandrum (IN); Pushparani M. Dominic, Bangalore (IN); Divya Vaipeyam, Sandhausen (DE)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/334,632

(22) Filed: Dec. 31, 2002

(51) Int. Cl. H04L 9/00

(52) U.S. Cl. 713/201

(57) ABSTRACT

The present invention provides a generic communication system for configuring substantially simultaneously one or more remotely located devices in a computer system. A generic communication system establishes physical and logical connection between clients running on a computing platform and remote security devices. A unique client identification is assigned to each client trying to access the one or more devices. Further, a session handler for each of the assigned unique client identifications is generated. Physical and logical connections with the one or more devices are established by dynamically assigning associated transmission media components and protocols based on the generated session handlers and the assigned unique client identifications. The system uses a Component Object Model (COM) based design for communication software. The generic communication system reduces the time required to make changes to the communication software in terms of design, development, and testing by narrowing the changes to be made to specific components requiring changes rather than revising the all of the communication software.

### FIELD OF THE INVENTION

This invention generally relates to data processing and more particularly to a generic communication server engine for data transfer, between a computing platform and one or more security devices.

### BACKGROUND

A control panel is the brain of a security system. Detectors and devices coupled to the control panel communicate with the control panel. The control panel reacts depending on the information it receives from various sensors. In a typical security domain, one or more control panels are generally coupled to a remote computing platform for configuring and monitoring the control panels. Configuring and monitoring generally includes data transfer between the remote computing platform and the control panels. Data transfer between the computing platform and the control panels can include data transfer activities, such as downloading data, uploading data, and receiving status messages, alarms, and notifications. Such data transfer activities between the remote computing platform and the control panel are performed by communication software residing in the computing platform. Downloading data includes data that is sent to the control panel from the computing platform through the communication software. Uploading data includes receiving data from the control panel by the computing platform through the communication software. Status messages are continuous polling data, which are sent by the control panel to the computing platform through the communication software upon request. Alarms are notifications from the panel when there is a fault, trouble or any abnormal behavior at the control panel end. In such case, the control panel will make a call to the software and send the alarms.

Currently, the communication software used by the security industry is designed to configure a specific type of control panel. Changes in the control panel hardware generally require developing new communication software. Developing new communication software is generally expensive and time consuming. In addition, current communication software is not designed to handle dynamic changes in the control panel hardware and any changes in the control panel hardware generally require extensive changes to the communication software in terms of design, development, and testing, which is generally not a desired solution.

### SUMMARY OF THE INVENTION

A generic communication system substantially simultaneously configures and monitors one or more remotely located control panels. The system in one embodiment uses a Component Object Model (COM) based design for communication software. The generic communication system reduces the time required to make changes to the communication software in terms of design, development, and testing by narrowing the changes to be made to specific components requiring changes rather than revising the all of the communication software.

In another embodiment, a generic communication system includes a computing platform and one or more remotely located control panels that are further coupled to security devices. The computing platform is coupled to the control panels through associated transmission mediums. The computing platform includes a client interface module coupled to a communication module through a transmission medium. In operation, the client interface module receives authenticating parameters from each client running on the computing platform and trying to gain access to the one or more security devices and assigns a unique client identification. The communication module then receives each of the assigned unique client identifications and generates a session handler to each of the received unique client identifications based on the assigned unique client identification. The communication module then establishes a physical and logical connection with an associated security device for each generated session handler by dynamically assigning an associated media component and a protocol for substantially simultaneous configuring of the one or more security devices.

Other aspects of the invention will be apparent on reading the following detailed description of the invention and viewing the drawings that form a part thereof.

### BRIEF DESCRIPTION OF THE DRAWINGS

The present subject matter is illustrated by way of example, and not by way of limitation, in the figures of the accompanying drawings in which like reference numerals refer to similar elements.

FIG. 1 is a schematic diagram illustrating one embodiment of a generic communication system for a COM-based network according to the claimed subject matter.

FIG. 2 is a flowchart illustrating one embodiment of performing data transfer operations in a COM-based computer network system according to the claimed subject matter.

FIG. 3 shows an example of a suitable computing system environment for implementing embodiments of the present invention, such as those shown in FIGS. 1 and 2.

### DETAILED DESCRIPTION

In the following description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled. The following description of the preferred embodiments and various features of the invention are grouped together in a single embodiment for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single disclosed embodiment. Thus the following claims are hereby incorporated into the description of the preferred embodiments, with each claim standing on its own as a separate preferred embodiment of the invention.

The present invention provides a generic communication system for configuring and monitoring substantially simultaneously one or more remotely located control panels. This is accomplished by adopting a Component Object Model (COM) based design in one embodiment, or other type of component model allowing ease of component or object interaction. The communication system includes a software component that connects with other software components at run time to form an application. Modifications and enhancements to the generic communication system is a simple matter of replacing or modifying one of these software components. Further, the scope of testing the generic communication system can be narrowed to only the newly developed or modified software component, which can reduce the testing effort.

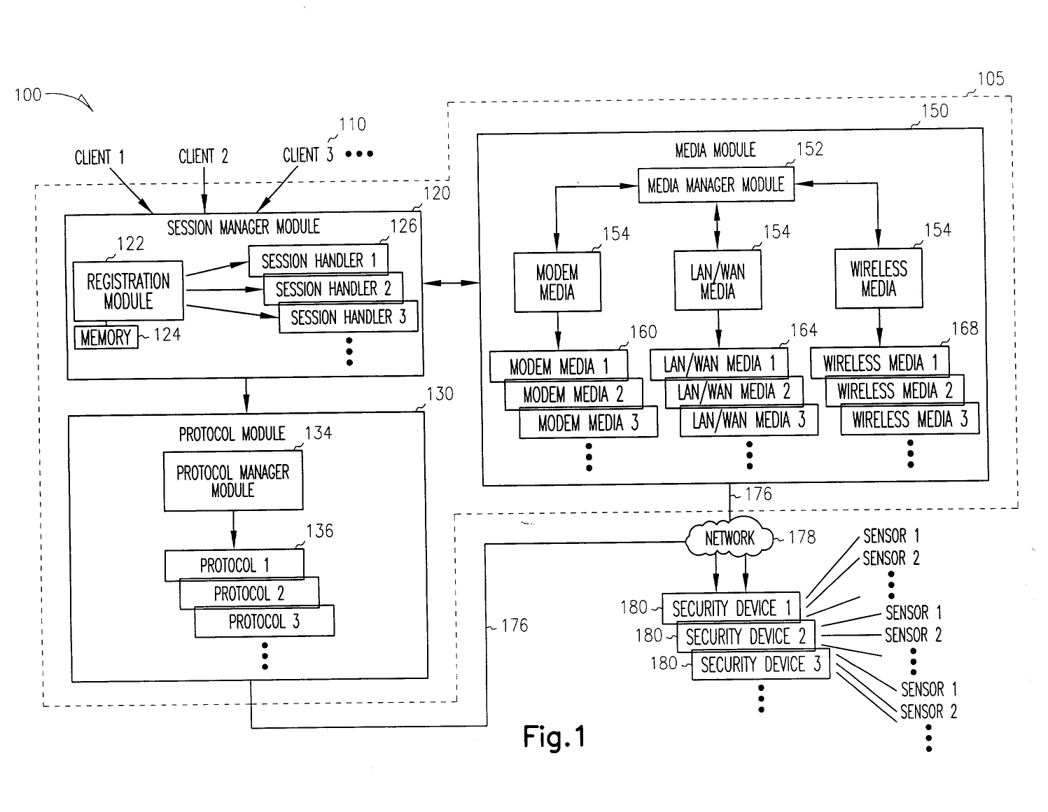

FIG. 1 is a schematic diagram having communication software 100 executing on a computing platform. The communication software 100 provides communication services between one or more clients running on the computing platform and one or more security devices 180 via different communication medium. A generic COM-based communication module 105 and the one or more clients 110 gain access to one or more security devices through transport mediums 176 connected through a network 178. Clients are computer programs that need to interact with the security devices. Such interactions include exchanging information related to polling, uploads, downloads, configuring, status messages, alarms or notifications and other communications as needed for interaction between the computing platform and the security devices.

FIG. 1 includes an example of a generic COM-based communication module 100 including software components/modules, such as a session manager module 120, a media module 150, and a protocol module 130. As shown in FIG. 1, session manager module 120 includes a registration module 122 and one or more session handlers 126 generated by the session manager module 120. Also as shown in FIG. 1, media module 150 includes a media manager module 152, one or more media groups 154 and their associated one or more media, such as one or more modem media 160, one or more LAN/WAN media 164, and one or more wireless media 168. Further, FIG. 1 shows one or more security devices 180 coupled to media module 150 and protocol module 130. In addition, FIG. 1 shows session manager module 120 further including memory 124 to store generated unique client identifications.

In some embodiments, one or more security devices 180 comprise security control panels, fire control devices, access control devices or any other devices requiring data transfer operations, such as to hardware/firmware. Also in these embodiments, transmission mediums include mediums, such as a model cable, a fiber optic cable, a category 5 (CAT 5) cable, and/or a wireless media. Further in these embodiments, communication module can include computing platforms, such as a personal computer, a laptop computer, a set-top box, a hand-held device and/or a processor. In other embodiments, one or more security devices 180, one or more clients 110, and communication module 105 include input/output (I/O) devices to access transmission mediums 176. In these embodiments, I/O devices can be devices, such as a modem, a network interface card (NIC), and a LAN on a motherboard. Network 178 can be a local area network (LAN) and/or a wide area network (WAN).

In operation, one or more clients 110 send requests to establish a session with one or more associated security devices 180 by sending authenticating parameters to communication module 105. Session manager module 130 receives the authenticating parameters from the one or more clients 110 and generates unique client identifications upon a request from the one or more clients 110 to start a session with associated one or more security devices 180. Session manager module 120 then generates a unique session handler 126 based on each of the generated unique client identifications.

Communication module 105 then establishes both physical and logical connections with each of the one or more associated security devices 180 for transferring data substantially simultaneously between the one or more clients 110 and the associated one or more security devices 180. Establishing a physical connection means establishing a connection between the client, communication module, and the associated security device through physical communication devices, such as modem media, telephone exchange, LAN/WAN media, and/or wireless media. Establishing a logical connection means establishing a connection between the client, communication module, and the associated security device by sending any packets as per the protocol specification and authenticating with the associated security device. Once the physical and logical connections are established between the client, communication module, and the associated security device, the client can perform data transfer activities like upload, download, and obtain status data.

In some embodiments, transferring data includes transmitting and receiving data between one or more clients 110 and one or more associated security devices 180 through communication module 105. Data transfer activities can include operations, such as downloading data from one or more clients 110 to one or more associated security devices 180, uploading data from one or more security devices 180 to one or more associated clients 110, and receiving status messages from the one or more security devices 180 to one or more associated clients 110.

In some embodiments, media module 150 establishes and manages the physical connections between one or more clients 110 and the associated one or more security devices 180 upon receiving the associated session handlers 126 from session manager module 120. In these embodiments, protocol module 130 establishes and manages the logical connections between the one or more clients 110 and associated one or more security devices 180 through transmission medium 176, when session manager module 120 receives information from media module 150 of successful completion of the physical connections with the associated one or more security devices 180.

In some embodiments, registration module 122 further passes the type of media needed, along with the generated unique client identification, to gain access and transmit data to the associated security device. In these embodiments, session manager module 120 generates a session handler 126 for each of the received unique client identifications based on the media type used by the client to gain access to the associated one or more security devices 180.

In some embodiments, media manager module 152 dynamically assigns and manages a media group in the one or more media groups to each of the session handlers received from session manager module 120. Based on the received session handlers and associated unique client identifications, media manager module 152 further generates a media to establish a physical connection with the associated security device. Also in these embodiments, one or more media groups include one or more similar media in each of the one or more media groups to establish physical connections upon receiving one or more session handlers 126 including similar media types. Further in these embodiments, media manager module 152 does not establish the physical connection with a session handler, when the unique client identification received from the session handler cannot be authenticated with the associated security device.

In some embodiments, protocol manager module 134 receives session handlers 126 from session manager module 120, when media manager module 152 successfully establishes physical connection with the associated one or more security devices 180. Protocol manager module 134 then dynamically assigns protocols to each of the received session handlers 126 based on the received session handlers 126 including media type information to establish logical connections using transmission medium 176 to the associated one or more security devices 180.

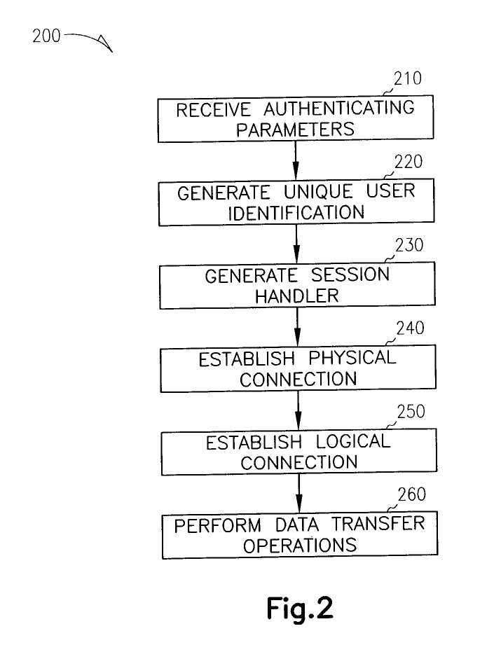

FIG. 2 is a flowchart illustrating one example embodiment of a process 200 for performing data transfer operations using a generic COM-based communication module including one or more software components according to the present invention. The flowchart includes operations 210-260, which are arranged serially in the exemplary embodiment. However, other embodiments of the invention may execute two or more operations in parallel using multiple processors or a single processor organized as two or more virtual machines or sub-processors. Moreover, still other embodiments implement the operations as two or more specific interconnected hardware modules with related control and data signals communicated between and through the modules, or as portions of an application-specific integrated circuit. Thus, the exemplary process flow is applicable to software, firmware, and hardware implementations.

The process begins with operation 210 by receiving authenticating parameters from one or more clients trying to gain access to one or more security devices to perform one or more sessions on the associated one or more security devices. Operation 220 includes generating a unique client identification based on client-entered authenticating parameters for each of the one or more clients for the session. Operation 220 can also include generating a unique client identification number.

In some embodiments, clients gain access to the communication module by registering with the computing platform. Registration can include providing authenticating parameters. Upon registration, a unique client identification is assigned to the client. Each connection to the associated security device a client makes through the communication module for a session is uniquely identified by the assigned unique client identification. This assigned unique client identification is used throughout the session for all interactions between the client and the associated one or more security devices. In these embodiments, multiple clients can connect to multiple security devices through the communication module. Each client is assigned a unique client identification that is used throughout the associated session for all interactions between the multiple clients and their associated multiple security devices.

In some embodiments, security devices 180 include devices, such as security control panels, fire control devices, access control devices, and any other devices requiring data transfer operations to hardware. One or more security devices can also be coupled to multiple sensors, such as motion detectors, glass breakage detectors, fire sensors, CO sensors, temperature sensors, etc. In some embodiments, the COM-based communication module can reside in a computing platform, such as a personal computer, a laptop computer, a server, a set-top box, a hand-held device, a processor, and other such platforms. The communication module can also be a remotely located computing platform. In some embodiments, the one or more security devices can be coupled to the one or more clients and the communication module through a network, such as LAN and/or WAN. In some embodiments, each of the one or more clients, one or more security devices, and the computing platform include an I/O device to access the transmission medium. The I/O Device can be a modem, a network interface card (NIC), a LAN on a motherboard, and so on.

Operation 230 includes generating a session handler for each of the generated unique client identifications based on the type of transmission media used by the client to gain access to the security device. In some embodiments, session handlers are generated to perform routine data transfer operations between a client and an associated security device, when initiated by the communication module. In other embodiments, session handlers are generated to perform data transfer operations between the one or more security devices and the communication module, when required by the one or more security devices to send status messages to the communication module.

Operation 240 includes establishing a physical connection between the client and the associated security device for each generated session handler. In some embodiments, establishing a physical connection includes checking for the physical communication media like modem, LAN/WAN etc A physical connection is established between the client and the associated one or more security devices for each received session handler.

Operation 250 includes establishing a logical connection between the client and the associated security device based on the session handler for each generated session handler after a successful completion of the physical connection with the associated security device. In some embodiments, an associated protocol is assigned based on a protocol query performed by the session handler to establish a logical connection with the associated security device for each generated session handler. In some embodiments, establishing a logical connection includes authenticating the client trying to gain access to the one or more security devices to perform a session. Also in these embodiments, a logical connection is established after successful completion of the associated physical connection.

Operation 260 includes performing data transfer operations substantially simultaneously between the one or more clients and the associated one or more security devices after successful completion of physical and logical connections between the one or more clients and the associated one or more security devices. In some embodiments, data transfer operations include transmitting and receiving data substantially simultaneously between the one or more clients and the associated one or more security devices through the communication module. Data transfer activities can include downloading data from the communication platform to the one or more security devices, uploading data from the one or more security devices to the communication platform, and/or receiving status messages from the one or more security devices upon a request by the communication platform.

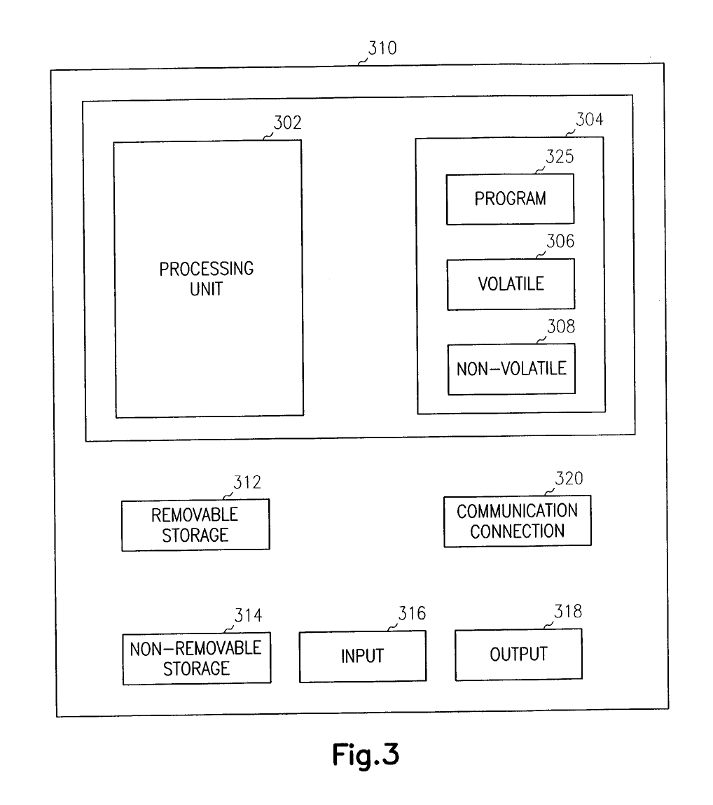

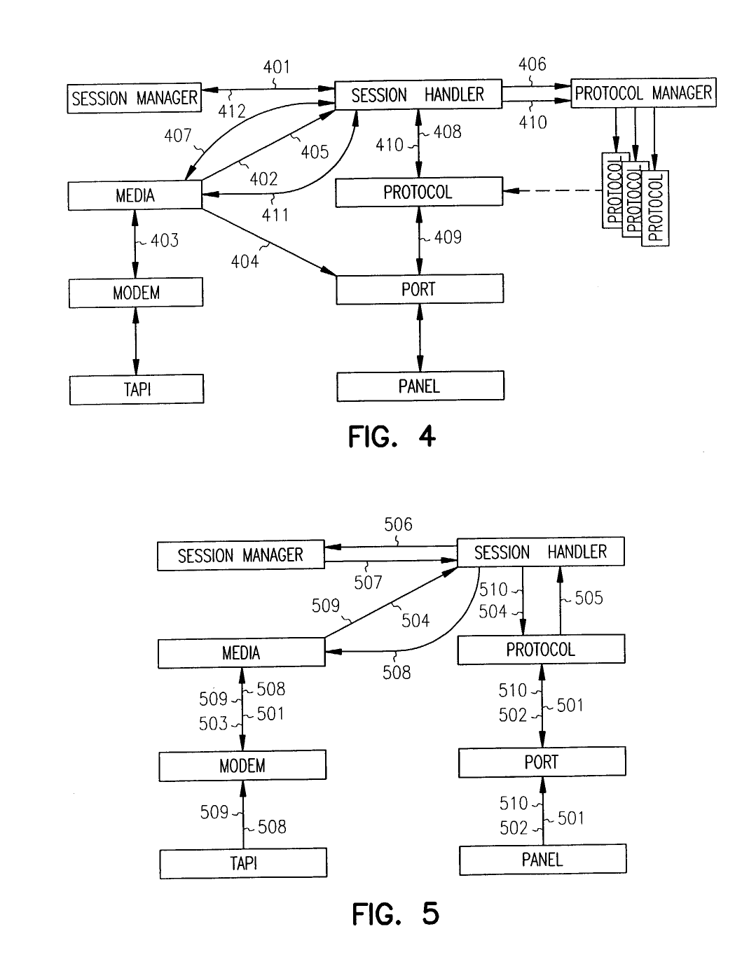

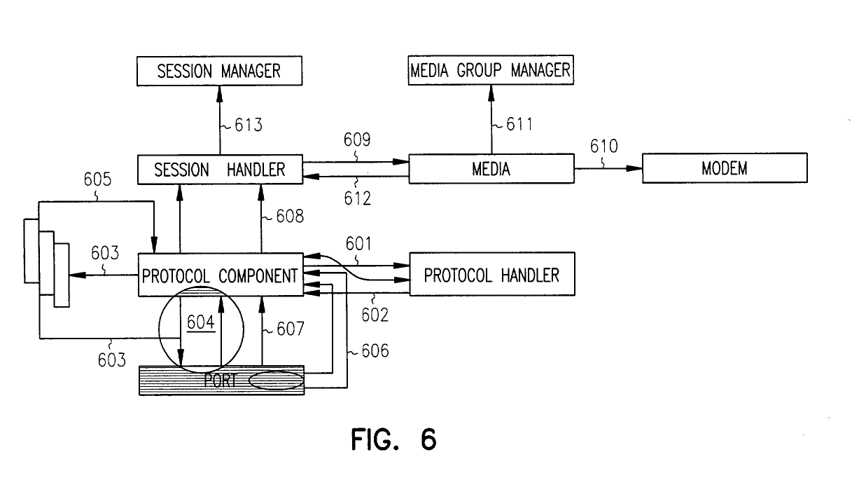

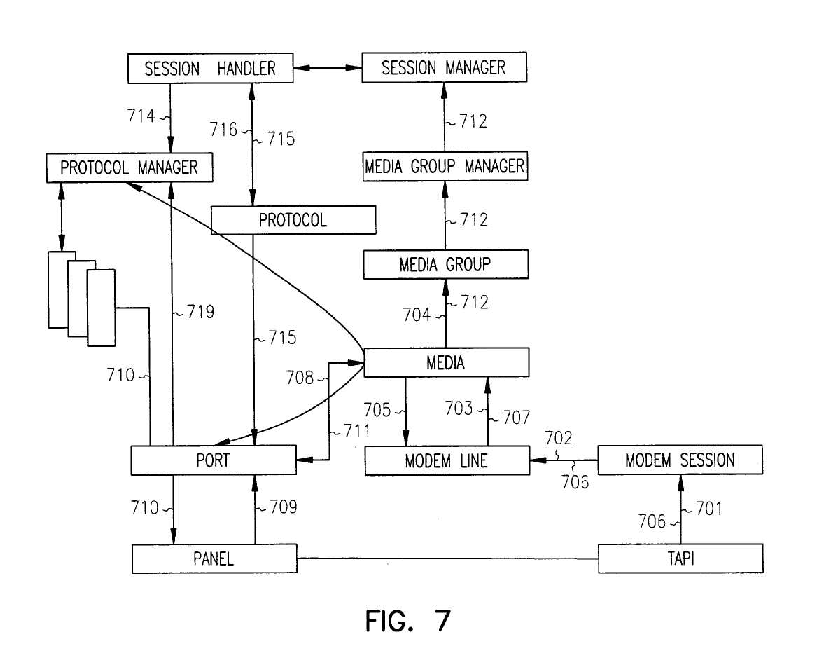

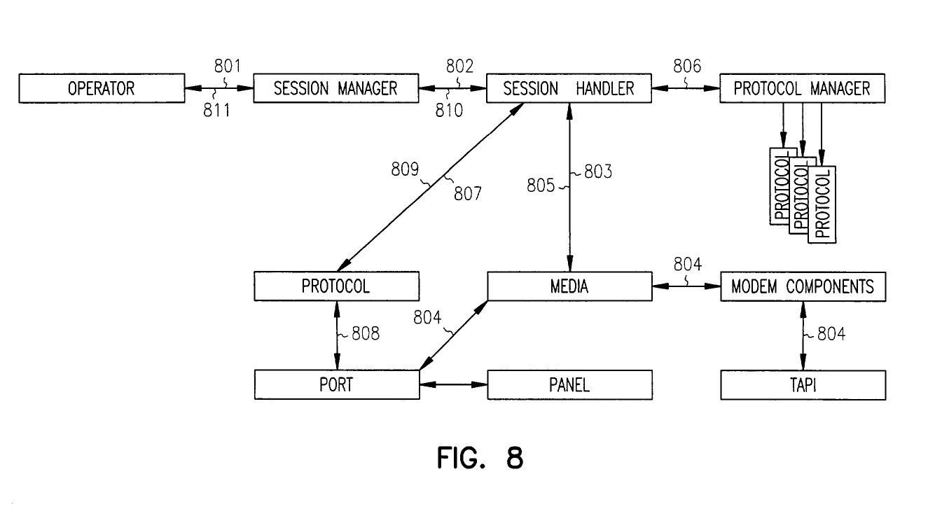

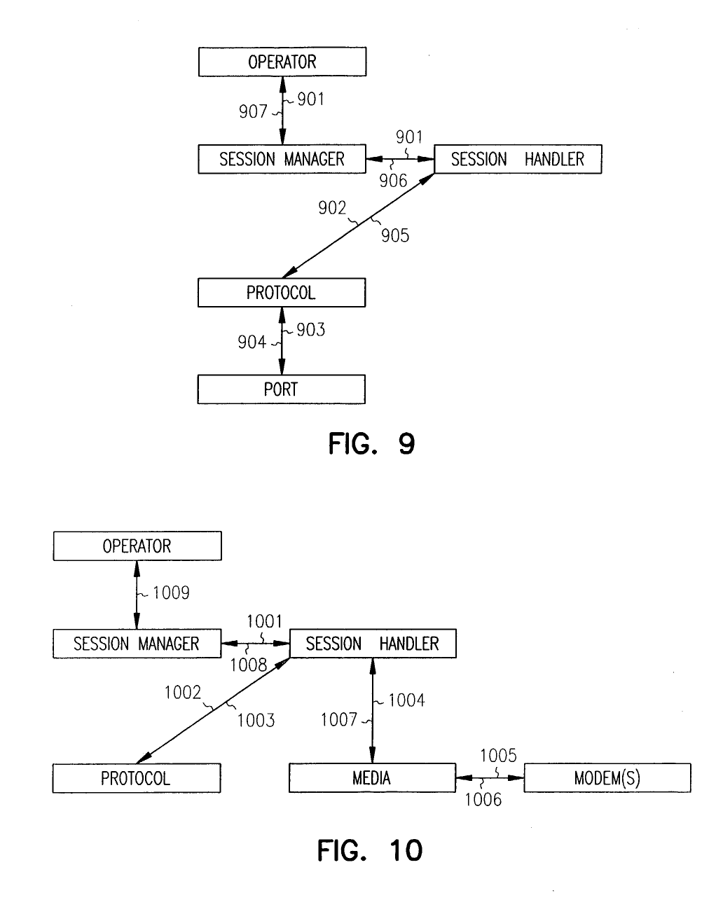

FIG. 3 shows an example of a suitable computing system environment 300 for implementing embodiments of the present invention. Various aspects of the present invention are implemented in software, which may be run in the environment shown in FIG. 3 or any other suitable computing environment. The present invention is operable in a number of other general purpose or special purpose computing environments. Some computing environments are personal computers, server computers, hand-held devices, laptop devices, multiprocessors, microprocessors, set-top boxes, programmable consumer electronics, network PCs, minicomputers, mainframe computers, distributed computing environments, and the like. The present invention may be implemented in part or in whole as computer-executable instructions, such as program modules that are executed by a computer. Generally, program modules include routines, programs, objects, components, data structures and the like to perform particular tasks or to implement particular abstract data types. In a distributed computing environment, program modules may be located in local or remote storage devices.

FIG. 3 shows a general computing device in the form of a computer 310, which may include a processing unit 302, memory 304, removable storage 312, and non-removable storage 314. Memory 304 may include volatile memory 306 and non-volatile memory 308. Computer 310 may include—or have access to a computing environment that includes—a variety of computer-readable media, such as volatile memory 306 and non-volatile memory 308, removable storage 312 and non-removable storage 314. Computer storage includes RAM, ROM, EPROM & EEPROM, flash memory or other memory technologies, CD ROM, Digital Versatile Disks (DVD) or other optical disk storage, magnetic cassettes, magnetic tape, magnetic disk storage or other magnetic storage devices, or any other medium capable of storing computer-readable instructions. Computer 310 may include or have access to a computing environment that includes input 316, output 318, and a communication connection 320. The computer may operate in a networked environment using a communication connection to connect to one or more remote computers. The remote computer may include a personal computer, server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 302 of the computer 310. A hard drive, CD-ROM, and RAM are some examples of articles including a computer-readable medium. For example, a computer program 325 capable of providing a generic communication system for COM-based systems according to the teachings of the present invention may be included on a CD-ROM and loaded from the CD-ROM to a hard drive. The computer-readable instructions allow computer system 310 to provide generic access controls in a COM-based computer network system having multiple clients and servers.

A series of use case scenarios are presented in FIGS. 4-10.

Startup

The client instantiates the communication server by creating an instance of the SessionManager component. In case of WindowsNT the Communication Server is a service and hence will be created when the service starts.

The SessionManager creates the ProtocolManager, which is a singleton component. The ProtocolManager in turn creates all the Protocol components that the Comm Server currently supports.

The SessionManager component creates the MediaGroupManager component.

The MediaGroupManager component in turn creates a list of MediaGroup components.

The MediaGroup component creates a ModemSession component.

The ModemSession component spawns Session Thread that starts a TAPI session by initializing it. Furthermore, it identifies all the modem devices connected to the communication server & passes on this information to the MediaGroup component.

The MediaGroup component creates Media components for each identified device. It then calls the Media's initialize function.

In the Media's Initialize function the Media creates the ModemLine component. There is a one to one ratio between the Media component & the ModemLine component.

The Media component creates the SerialPort component after a physical connection has been established successfully with the panel

The Protocol component creates the Protocol Handler component for translating the data in XMLformat to Protocol format or vice-versa.

Shutdown

The Communication server is shutdown by destroying the SessionManager component. In case of WindowsNT the SessionManager is destroyed when the service stops.

The MediaGroupManager component is destroyed while destroying the SessionManager component

The list of MediaGroup components is destroyed while destroying the MediaGroupManager component.

The ModemSession component and the Media components are destroyed while destroying the MediaGroup component.

The ModemLine component is destroyed while destroying the Media Component. The SerialPort component is destroyed while destroying the Media component.

The SessionManager destroys the ProtocolManager, which in turn destroys all the protocols.

OutGoing Call (StartCall) is shown in FIG. 4 in block flow format. Reference numbers are used to identify activities and the order in which they are performed.

401 The SessionManager gets a free Media, spawns a new thread, and creates a SessionHandler on this thread.

402 The SessionHandler initiates a physical connection (Connection using TAPI) with the Media passed in.

403 The Media instantiates a physical connection using the Modem components (Modem Session & Modem Line).

404 Whenever the Media is at this point it creates the Port component & initializes it using the port handle it obtained from the Modem.

405 The Media calls back on the SessionHandler with a connected notification.

406 With the AccountId that is passed from the client, the PanelType is found and the SessionHandler queries the ProtocolManager for a protocol that supports this panel.

408 The SessionHandler queries the Media object for the port object.

409 The SessionHandler instantiates the Protocol component passing in the port object & the XML data.

410 The Protocol uses this Port object for sending data to the panel. Once all the data has been downloaded to the panel, the protocol does a logical disconnect & informs back on the SessionHandler. The SessionHandler returns the protocol back to the ProtocolManager.

411 The SessionHandler initiates a physical disconnect on the Media. After the disconnection the Media informs the SessionHandler.

412 The SessionHandler informs the SessionManager of the outcome.

413 The SessionManager performs the necessary cleanup thus ending the outgoing call.

Handling A typical behavior during an OutgoingCall Scenario is shown in FIG. 5. A Physical disconnection occurs during data transmission.

501 The physical and the logical connection are established.

502 The Protocol component is sending messages through the Port onto the Panel.

503 A disconnect comes due to some cause, it's propagated by TAPI to the Modem components which passes it to the Media associated with the line. If the ModemLine notifies the Media regarding LINEDEVSTATE_OUTOFSERVICE then the Media is put in OUT_OF_SERVICE list.

504 The Media will inform the SessionHandler to do a logical disconnect by initiating Protocol's disconnect.

505 The Protocol finds that it is left with more messages in its outgoing queue to be sent to the Panel and hence callsback SessionHandler with DisconnectFailed and also informs the reason for failure as Message waiting to download.

506 The SessionHandler asks SessionManager for a free Media, to continue on downloading of the messages.

507 The SessionManager obtains a free Media from the MediaGroup through the MediaGroupManager and passes it on to the SessionHandler.

508 Now the SessionHandler initiates a physical connection.

509 Once the physical connection is established it informs the SessionHandler.

510 The SessionHandler will initiate the logical connection on the Protocol, obtain the PortObject and passes it on to the Protocol component, which will initialize its callback with the Port component, and starts sending the messages that were left in its outgoing queue.

511 When in step 6 or in step 8, there could be an incoming call from the same Panel. In this case, since incoming calls have the highest priority the previous outgoing call has to be cancelled i.e., the messages that are waiting to be downloaded have to be discarded.

512 The incoming call would have established the physical connection and the Media associated with the particular line of the incoming call would inform the SessionManager about the incoming call.

513 The SessionManager checks if there's any call in progress for that AccountId, if yes the SessionManager will ask SessionHandler to cancel the call.

514 The SessionHandler checks its current state which could be either in the process of getting a free Media for the previous outgoingcall which had a physical disconnect, or after getting a new Media had initiated the physical connection. In the first case it initiates a logical disconnect and in the latter it initiates physical as well logical disconnect.

515 The SessionHandler informs Protocol to disconnect by setting the mode of disconnect to active. When it is active disconnect message for the Protocol, the Protocol does a disconnection irrespective of its current state.

516 The SessionHandler informs back the SessionManager about the failure of the previous outgoing call.

517 The SessionManger informs the client which initiated the previous outgoing call that the request has failed.

518 In the meanwhile, the SessionManager would create a new SessionHandler to handle the incoming call.

519 When in step 509, if the physical connection could not be established

520 The SessionHandler is informed about this and the does a Protocol.disconnect with the mode of disconnect as active disconnect.

521 Now the Protocol knows that for some reason it has to discard the messages and hence callback SesssionHandler with disconnected.

522 The SessionHandler informs SessionManager about this and the SessionManager informs the client which initiated the outgoing call that the request has failed.

Send message part of Outgoing call is shown in FIG. 6. Once the Connection is established for an Outgoing call, the Send Message starts as follows.

601 The Protocol Component creates the Protocol handler component & calls its Initialize function. This component takes care of deciphering the XML data using the XML utility component.

602 After the data is deciphered the protocol handler calls back on the Protocol Component with the message to sent to the panel.

If this is the first frame it is send to the port otherwise it is placed in the outgoing queue.

603 The port maintains a Monitor thread that waits for a port related event object to be set. It services the event and returns to a wait state. When transmission is fully completed a Fire_TransmitDone event is fired on the port call back to the protocol component.

604 The Protocol component contains a timer thread that periodically gets the next frame to send & sends it to the panel. Timer thread repeats steps 4 & 5 until the no of retries are over or the panel answers back with an acknowledgement of the frame sent whereupon the next message to be sent is retrieved from the queue sent to the Panel. The arrows in red indicate the path followed for the upload data.

605 When the data comes to the port, it is passed to the protocol. The protocol uses the handler component for deciphering this data. The protocol component calls on the SessionHandler, which retrieves this data asynchronously. This data is then passed to the SessionManager.

606 When there are no more messages to send, the protocol's Disconnect function is called. The protocol's state is set to PROTOCOL_DISCONNECTING. A DataFrame with the EOT frame type is sent to the port. When the port answers back, it means the panel has acknowledged the termination of link. The Protocol's state is set to PROTOCOL_DISCONNECTED. The Port monitor thread is Shutdown and any IO operation that is in progress is killed. Discard protocol callback references.

607 IProtocolCallBack::Disconnected is called on the SessionHandler. The SessionHandler's state is set to SH_DISCONNECTING.

608 The SessionHandler initiates a physical disconnect by calling Media.Disconnect.

609 The Media tells the Modem to go on hook. The following steps are performed inside the modem component

Close the serial port handle TAPI provided for the user to communicate.

Drop (hang up) the current call.

Release system resources allocated to the call by TAPI.

Clear call handle and set Call State to IDLE. The Media restores the default No Answer Timeout. Sets Connection State to idle. I.e.

MEDIA_IDLE.

610 Notify the MediaGroup that the Media has been freed. The MediaGroup changes the status of the Media from in use to in waiting (It does not directly set the status to free. The status timer in the Media takes care of this)

611 The Media calls back on the SessionHandler informing the call has disconnected using IMediaCallBack::Disconnectedo. The SessionHandler's state is changed to SH_DISCONNECTED.

612 The SessionHandler informs the SessionManager of the outcome using ISessionHandlerCallBack::CallEnded( )

Incoming Calls are shown in FIG. 7.

701 When a new call arrives TAPI informs the Monitor thread in ModemSession component.

702 The ModemSession component informs the ModemLine component of the Incoming call

703 The ModemLine component fires a CallOferring event to the Media. Media's state is set to MEDIA_ANSWERING. Alert the MediaGroup that the Media is no longer available through IMediaUpdate::IncomingCall.

704 A Media calls this method when the Media hardware detects an incoming call signal. The Media's status is changed to InUse mode.

705 The Media tells the ModemLine component to answer the call using ModemLine::AnswerCall. This call waits indefinitely until TAPI sends a notification to the ModemLine component through the ModemSession component.

706 When a call connectedEvent arrives through TAPI it is trapped by the ModemSession component & sent to the ModemLine component.

707 The ModemLine component fires a CallConnected event to the Media. The state of the Media is checked at this point. If it is MEDIA_ANSWERING that means that it is an Incoming call.

708 The Media creates the Port component at this point & initializes it by passing the port handle to it. The Port creates a monitor thread that traps any events coming from the panel.

709 The Media gets a pointer to the ProtocolManager & passes it to the Port.

710 The Port calls the Protocol Manager & does the following operations

It queries for the IportCallBackOnProtocol interface & stores it.

It calls an appropriate function of the ProtocolManager passing in a reference to itself.

The Protocol Manager does the following things

It iterates through its list of protocols trying to establish a logical connection with the panel through the port.

When one of the protocol establishes a logical connection it sends 5A5A to the panel.

The panel answers back with an Incoming Frame. The ProtocolManager retrieves the AccountID of the panel from this frame. The Protocol Manager returns this AccountID to the port. The Protocol Manager does the following entries in a list it maintains.

| | | |
|---|---|---|
| Account ID | State | Protocol Pointer |

The Protocol Manager makes an entry in this table.

711 The Port passes it to the Media.

712 The Media informs the SessionManager of the IncomingCall.

713 The SessionManager spawns a new thread, creates a new SessionHandler on this thread, passing in the Media pointer & the AccountID.

714 The SessionHandler gets the protocol that was instantiated previously using the AccountID from the Protocol Manager.

715 The SessionHandler uses the protocol pointer to receive messages, which it passes to the SessionManager.

716 Once all the messages have been retrieved, the protocol cleans itself up, removes its reference to the port object & informs the SessionHandler.

717 The Session Handler does a physical disconnect. As a part of this, the Media releases the port object. After this the SessionHandler informs back on the SessionManager with a CallCompleted notification.

A typical Behavior—Call Coming in as a Part of CPC.

The Port component passes the incoming frame to the Protocol Manager as specified above. The Protocol Manager gets the AccountID as in previous case. It checks the its List. In case of a CPC there will already be an entry in the list with the OUTGOING call state. The ProtocolManager has to do the following actions

Merge the state of the newly instantiated protocol component with that of the old one.

Give the new port handle to the old protocol component & start the logical connection

Pass the AccountID back to the port object.

Like the usual Incoming call the SessionManager is informed about the IncomingCall. The SessionManager checks its list, finds an entry for this AccountID. It calls CancelCall on this SessionHandler. The SessionHandler's state at this point is SH_CPC. The SessionHandler informs the SessionManager that this call cannot be cancelled as its part of a CPC. The SessionManager then proceeds as usual with the rest of the Outgoing call.

A typical Behavior—Incoming call coming in while an Outgoing call has been just initiated by the SessionHandler.

When the AccountId is passed to the SessionManager, it checks its list & upon finding an OutGoing call sends a CancelCall to the SessionHandler. The SessionHandler aborts this call & informs back on the SessionManager upon which the Incoming call can proceed ahead.

Explicit connect refers to the scenario when the user directly connects to the panel through the UI, and is shown in FIG. 8.

801 The operator calls SessionManager's connect function. In the connect function, a new thread is spawned, a free Media is obtained, a new SessionHandler created, the necessary entries made in the calllist

802 Then it calls SessionHandler's connect function.

803 The SessionHandler calls on Media's connect. SessionHandler's state is set to SH_CONNECTING.

804 The Media establishes a physical connection first. The details are same as the normal connect scenario. The Media also creates the Port and passes on the PortHandle to the Port.

805 The Media callsback on the SessionHandler with the connected notification. SessionHandler's state is set to SH_PHYSICAL_CONNECTED.

806 The SessionHandler initiates the logical connect by getting the appropriate Protocol from the ProtocolManager. The SessionHandler passes the PanelType to the ProtocolManager to get the Protocol Component.

807 The SessionHandler will pass on the PortObject to it. The point to note here is that through the connect parameters the Protocol knows that this is an explicit connect.

808 The Protocol sets itself to PROTOCOL_CONNECTING. It then continues with the logical connection. When the logical connection is established the protocol's state is set to PROTOCOL_EXPLICIT_CONNECTED.

It calls back on the SessionHandler with a connected notification. The SessionHandler's state is set to SH_CONNECTED.

809 The SessionHandler calls back on the SessionManager with a callconnected event.

810 The SessionManager retrieves the client callback for this AccountId and informs the client regarding the status of connect. It removes this entry then from this table. This completes the explicit connect scenario.

Handling A typical behavior during Explicit Connect scenario

Operator does a Disconnect:

SessionManager's disconnect is called. SessionManager checks the calllist, gets the SessionHandler for this call from the AccountId.

SessionManager calls SessionHandler's disconnect function.

SessionHandler which does a physical disconnect, logical disconnect or both depending on its state at this point. (SH_PHYSICAL_CONNECTED, SH_CONNECTED).

Physical disconnect is initiated by the invoking Media.disconnect. Media calls back on the SessionHandler with a disconnected notification. SessionHandler initiates logical disconnection by invoking Protocol.disconnect with the mode of disconnect as Active.

Once the SessionHandler gets a disconnected notification from the Protocol, it calls back on the SessionManager with a disconnected notification. SessionManager removes the call entry from the calllist thus releasing the thread & the SessionHandler component associated with this component. SessionManager informs the client regarding the outcome of the disconnect.

Explicit Command Mode (Send Message) is shown in FIG. 9.

901 The operator initiates a download command to the CommServer. The SessionManager gets the threadID from the AccountId passed in, creates the SendMsg event for this thread & signals the thread. It updates the calllist table also. This thread does a SendMsg call on the SessionHandler.

902 The SessionHandler in turn calls the Protocol's SendMsg and passes in the XML data. Th protocol uses the handler component for deciphering this data in a panel readable format. It stores this data in a queue.

903 The protocol uses the port component for sending the data to the panel.

This goes on in a loop until there are no more messages to send.

904 The protocol informs the SessionHandler of the command completion. It then waits indefinitely until further messages or a disconnect comes from top. The Protocol's state at this point is PROTOCOL_IDLE.

905 The SessionHandler calls back on the SessionManager with a CallCompleted or CallAborted event depending on the status passed in the CommandResponse method of ProtocolCallback.

906 The SessionManager gets the command type & calls the appropriate callback on the client.

Handling A typical behavior during Explicit SendMsg scenario Operator calls CancelCall

SessionManager calls SessionHandler's CancelCall. SessionHandler does an Activedisconnect on Protocol. Whenever the Protocol gets an Active disconnect from SessionHandler, the Protocol aborts the transmission and also discards the messages in Outgoing queue. The type of disconnect is either active/passive, if active, it's like an abort, if passive the protocol has the option of calling back it's client saying it's did not disconnect.

Once the disconnected notification comes from the Protocol, the SessionHandler gives the Protocol to the ProtocolManager.

TAPI disconnects are handled like the Outgoing call's RecoveryMessage scenario when a physical disconnect happens.

Explicit Command Mode (Disconnect) is shown in FIG. 10.

1001 The SessionManager calls on the SessionHandler with a disconnect request. The request comes to the SessionManager from the client, which has the AccountId. The SessionManager gets the SessionHandler pointer from the calllist using this AccountId.

1002 The SessionHandler calls on the protocol with the disconnect notification. The protocol initiates the logical disconnection and does all cleanup.

1003 It calls back on the SessionHandler with a disconnected notification

1004 The Media initiates a physical disconnection.

1005 It calls on the Modem's to do the physical disconnect.

1006 The Modem after disconnection calls back on the Media with a disconnected notification

1007 The Media after doing a physical disconnect calls back on the SessionHandler saying that it disconnected. The SessionHandler's state is SH_DISCONNECTED.

1008 The SessionHandler calls back on the SessionManager with a disconnected notification.

1009 The SessionManager calls back on the client informing it of the result of the disconnect. It does the appropriate cleanup also. This completes the Explicit Disconnect command mode.

### CONCLUSION

The above-described invention provides a COM-based generic communication system including multiple software components that dynamically configures or monitors multiple remotely located security devices. Any modifications to the generic communication module only involves changing one or more software components. thus making it easier to support and test any changes made to the communication module.

The above description is intended to be illustrative, and not restrictive. Many other embodiments will be apparent to those skilled in the art. The scope of the invention should therefore be determined by the appended claims, along with the full scope of equivalents to which such claims are entitled.

What is claimed is:

1. A generic communication system, comprising:
one or more security devices to monitor information received from various sensors;
a computing platform coupled to the one or more security devices through a transmission medium; and
one or more clients coupled to the computing platform communicating with the one or more security devices, wherein the remote computing platform comprises a component based communication module including one or more modules that receive authenticating parameters from the one or more clients, dynamically assign a unique client identification to each of the one or more associated clients, and establish physical and logical connections with each of the one or more associated security devices for transferring data substantially simultaneously between the one or more clients and the associated one or more security devices.

2. The system of claim 1, wherein the security devices comprise:
devices selected from the group consisting of security control panels, fire control devices, access control devices, and any other devices requiring data transfer operations to hardware.

3. The system of claim 1, wherein the transmission medium comprises:
transmission medium selected from the group consisting of a modem cable, a fiber optic cable, a category 5 (CAT 5) networking cable, and a wireless media.

4. The system of claim 1, wherein the computing platform comprises:
a remote computing platform selected from the group consisting of a personal computer, a laptop computer, a server, a set-top box, a hand-held device, and a processor.

5. The system of claim 1, wherein transferring the data between the remote computing platform and the one or more security devices comprises:
transmitting and receiving data between the one or more clients and the one or more associated security devices through the computing platform.

6. The system of claim 5, wherein transmitting and receiving the data comprises:
data transfer activities selected from the group consisting of downloading data from the one or more clients to the one or more associated security devices, uploading data from the one or more security devices to the one or more associated clients, and receiving status messages from the one or more security devices to the one or more associated clients upon a request by the communication module.

7. The system of claim 1, wherein each of the one or more security devices, one or more clients, and the computing platform comprises an input/output (I/O) device to access the transmission medium, wherein the I/O device is selected from the group consisting of a modem, a network interface card (NIC), and a LAN on motherboard.

8. The system of claim 1, wherein the one or more modules comprise:
a session manager module coupled to the one or more clients, wherein the session manager module includes a registration module to generate the one or more unique client identifications upon a request from the one or more clients to perform a session with the associated one or more security devices, wherein the session manager module generates a unique session handler based on each of the generated unique client identifications;
a media module coupled with each of the generated unique session handlers from the session manager module and establish and manage the physical connections with the one or more associated security devices; and
a protocol module coupled to the session handler to establish and manage logical connections with the one or more security devices upon successful completion of the associated physical connections.

9. A communication system for establishing communications between one or more clients executing on a computing platform, and one or more remote security devices, the system comprising:
a session manager that receives client authenticating parameters and assigns a unique client identification to each client, wherein the session manager generates a session handler for each unique client identification;
a media module coupled with each session handler and establishes a physical connection with an identified remote security device; and
a protocol module that establishes a logical connection with each of the associated security devices, when the session handler receives information from the media module of a successful completion of the physical connection with the associated security device.

10. The communication system of claim 9 wherein the media module comprises multiple media.

11. The communication system of claim 10 wherein the media is selected from the group consisting of modem media, LAN/WAN media and wireless media.

12. The communication system of claim 9 wherein the session manager comprises a registration module for storing unique client identifiction.

13. The communication system of claim 9 wherein the communication system is a COM based system.

14. A method of establishing a communication session between one or more clients coupled to one or more security devices through a generic component based communication platform, the method comprising:
generating a unique client identification based on client-entered authenticating parameters;
generating a session handler for each unique client identification;
establishing a physical connection between the client and the associated security device for each generated session handler; and
establishing a logical connection between the client and the associated security device based on the generated session handler upon a successful completion of the physical connection with the associated security device.

15. The method of claim 14 wherein the logical connection is established by dynamically assigning a protocol for the physical connection.

16. The method of claim 14 and further comprising assigning a media from the mediagroup prior to establishing the physical connection.

17. A generic communication system for monitoring one or more remotely located security devices through a media in a COM-based computer network system, comprising:
a session manager module to receive one or more client entered authenticating parameters to log in to the one or more security devices to start a session and assign a unique client identification to each of the one or more clients for the session, wherein the session manager module dynamically generates a session handler for each received unique client identification;
a media module coupled to the session handler module to receive each of the generated session handlers and to establish and manage a physical connection with an associated security device the client is trying to gain access to, wherein the media module informs the session handler module of completion of the physical connection with the associated security device upon a successful completion of the physical connection with the associated security device; and
a protocol module coupled to the session handler module establishes and manages a logical connection with each of the associated security devices, when the session handler receives information from the media module of a successful completion of the physical connection with the associated security device, wherein the protocol module informs the session handler module upon successful completion of the logical connection with the associated control panel.

18. The system of claim 17, wherein the session manager module comprises:
a session manager module to generate the session handler for each of the received unique client identifications from the registration module based on the media type used by the client to gain access to the security device, when the registration module receives the unique client identification and the associated media type used by each of the clients from the registration module,
wherein the session manager module further generates a session handler to perform routine data transfer operations to the associated security device, when required by the system, and
wherein the session manager module further generates a session handler, when required by the security device to send status messages to the system.

19. The system of claim 18, wherein the media module comprises:
a media manager module coupled with the session manager module; and
one or more media groups coupled to the media manager module, wherein the media groups are formed based on media type, wherein the media manager module dynamically assigns and manages a media group in the one or more media groups to each of the session handlers received from the session manager module based on the received session handlers and associated unique client identifications and further generates a media to establish a physical connection with the associated security device.

20. The system of claim 19, wherein each of the one or more media groups further comprise one or more similar media in each of the one or more media groups to establish physical connections upon receiving one or more session handlers including similar media types.

21. The system of claim 20, wherein the media is selected from the group consisting of a direct media, a modem media, a LAN/WAN media, and a wireless media.

22. The system of claim 21, wherein the media manager module does not establish the physical connection with the session handler when there is any problem in the physical communication media like modem or in LAN/WAN
wherein a protocol module does not establish the logical connection when the unique client identification received from the session handler cannot be authenticated with the associated security device.

23. A generic data transfer system for communicating with multiple remotely located devices through a media in a COM-based computer network system, comprising:
a session manager module including a registration module to receive one or more client-entered authenticating parameters to log in to the multiple devices to start a session and assign a unique client identification to each of the one or more clients for the session, wherein the session manager module generates a session handler based on the received unique client identification and the device the client is trying to access for each of the received unique client identifications;
a media module coupled to the session manager module to couple media with each of the generated session handlers and establishes a physical connection with an associated device the client is trying to gain access, wherein the media module informs the session handler of completion of the physical connection with the associated device upon a successful completion of the physical connection with the associated device; and
a protocol module coupled to the session handler module establishes a logical connection with each of the associated devices, when the session handler receives information from the media module of a successful completion of the physical connection with the associated device, wherein the protocol module informs the session handler module upon successful completion of the logical connection with the associated control panel, wherein the session handler module manages the established logical and physical connections between one or more clients and the associated devices.

24. The system of claim 23, wherein the Session manager module generates the session handler for each of the received unique client identifications from the registration module based on the media type used by the client to gain access to the device, when the session manager module receives the unique client identification and the associated media type used by each of the clients from the registration module,
wherein the Session manager module further generates a session handler to perform routine data transfer operations to the associated device, when required by the system, and
wherein the Session manager module further generates a session handler, when required by the device to send status messages to the system.

25. The system of claim 24, wherein the media module comprises:
a media module coupled to the generated session handlers from the session manager module; and
a media group manager that manages one or more media group modules and the media group module manages one or more media that belong to that media group. The media group is formed based on the media type, wherein the media group manager dyanmically assigns the media to the session handler. The session handler module will then use the media module to establish physical connection with the associated security device.

26. The system of claim 25, wherein the media manager module further comprises multiple similar media handlers coupled to each of the multiple media groups based on the media type to establish a physical connection with multiple session handlers including similar media types.

27. The system of claim 26, wherein the protocol module comprises:
a protocol manager managing one or more protocol module that differs depending upon the panel.
one or more protocol components coupled to the protocol manager, wherein the protocol manager dynamically assigns a protocol component from the one or more protocol components based on the protocol type queried by the session handler wherein the assigned protocol component does the data deciphering and establishes a logical connection with the security device for each of the received session handlers and its associated media type

28. The system of claim 26, further comprising:
a port coupled to the protocol module that helps in transmission of data from the protocol to the panel and also receiving the data from the panel to the protocol. Once the initial handshaking is done i.e., transmission of data between the panel and the protocol is complete, the logical connection is established and the protocol module informs the session handler module.
The system of claim 26,
wherein the port comprises devices selected from the group consisting of types of physical port including Windows Sockets, Serial Port used for data transfer operations.

29. A method of performing data transfer operations between one or more clients coupled to one or more security devices through a generic COM-based communication platform including multiple software components, wherein the communication platform is coupled to the one or more security devices through one or more associated transmission mediums, comprising:
receiving authenticating parameters from the one or more clients trying to gain access to the one or more security devices to perform a session;
generating a unique client identification based on client-entered authenticating parameters for each of the one or more clients for the session;
generating a session handler for each generated unique client identification based on a type of transmission media used by the client to gain access to the security device;
establishing a physical connection between the client and the associated security device for each generated session handler;
establishing a logical connection between the client and the associated security device based on the generated session handler for each generated session handler, upon a successful completion of the physical connection with the associated security device; and
performing data transfer operations substantially simultaneously between the one or more clients and the associated one or more security devices, upon successful completion of the physical and logical connections between the one or more clients and the associated one or more security devices.

30. The method of claim 29, wherein generating the session handler for each generated unique client identification further comprises:
generating the session handler to perform routine data transfer operations between a client and an associated security device, when initiated by the communication platform; and
generating the session handler to perform data transfer operations between the one or more security devices and the communication platform, when required by the one or more security devices to send status messages to the communication platform.

31. The method of claim 30, wherein establishing the physical connection comprises:
establishing physical connections between the one or more clients and the associated one or more security devices and the transmission mediums for each of the session handlers, upon successful completion of the authentication.

32. The method of claim 31, wherein establishing a logical connection comprises: assigning an associated protocol based on a protocol query performed by the session handler to establish a logical connection with the associated security device.
authenticating the one or more clients trying to gain access to one or more security devices to perform a session.

33. The method of claim 29, wherein the data transfer operations comprise:
transmitting and receiving data substantially simultaneously between the one or more clients and the associated one or more security devices through the computing platform.

34. The method of claim 33, wherein transmitting and receiving the data comprises:
data transfer activities selected from the group consisting of downloading data from the communication platform to the one or more security devices, uploading data from the one or more security devices to the communication platform, and receiving status messages from the one or more security devices upon request by the communication platform.

35. The method of claim 29, wherein the one or more security devices comprise one or more remotely located security devices.

36. A method of communicating between a remotely located generic COM-based communication module and one or more control panels through their associated transmission mediums, comprising:
receiving authenticating parameters by the communication module from one or more clients trying to gain access to the one or more control panels to perform a session;
generating a unique client identification based on client-entered authenticating parameters for each of the one or more clients for the session;
generating a session handler for each generated unique client identification based on a transmission media type used by the client to gain access to the control panel;
establishing a physical connection between the communication module and the associated control panel based on the generated session handler for each generated session handler;
establishing a logical connection with the associated control panel based on the generated session handler for each generated session handler, upon completing a successful physical connection with the associated control panel; and
performing data transfer operations substantially simultaneously between the communication module and the one or more control panels, upon successful completion of the physical and logical connections between the communication module and the one or more control panels.

37. The method of claim 36, wherein establishing the physical connection comprises:
establishing a physical connection between the one or more clients and the associated one or more control panels by dynamically assigning associated transmission mediums for each of the session handlers, upon successful completion of the authentication.

38. The method of claim 37, wherein establishing a logical connection comprises:
dynamically assigning an associated protocol based on a protocol query performed by the session handler to establish a logical connection between the client and the associated security device for each generated session handler.
authenticating the one or more clients trying to gain access to one or more security devices to perform a session.

39. The method of claim 38, wherein the data transfer operations comprise:
transmitting and receiving data substantially simultaneously between the one or more clients and the associated one or more control panels.

40. A computer-readable medium having computer-executable instructions for performing data transfer operations between one or more clients and one or more security devices coupled through a remotely located communication module and associated transmission mediums, comprising:
receiving authenticating parameters from the one or more clients trying to gain access to the one or more security devices to perform a session;
generating a unique client identification based on client-entered authenticating parameters for each of the one or more clients for the session;
generating a session handler for each generated unique client identification based on a type of transmission media used by the client to gain access to the security device;
establishing a physical connection between the client and the associated security device for each generated session handler;
establishing a logical connection between the client and the associated security device based on the generated session handler for each generated session handler, upon a successful completion of the physical connection with the associated security device; and
performing data transfer operations substantially simultaneously between the one or more clients and the associated one or more security devices, upon successful completion of the physical and logical connections between the one or more clients and the associated one or more security devices.

41. The computer-readable medium of claim 40, wherein generating the session handler for each generated unique client identification further comprises:
generating the session handler to perform routine data transfer operations between a client and an associated security device, when initiated by the communication platform; and
generating the session handler to perform data transfer operations between the one or more security devices and the communication platform, when required by the one or more security devices to send status messages to the communication platform.

42. The computer-readable medium of claim 40, wherein establishing the physical connection comprises:
establishing physical connections between the one or more clients and the associated one or more security devices and the transmission mediums for each of the session handlers, upon successful completion of the authentication.

43. The computer-readable medium of claim 40, wherein establishing a logical connection comprises:
assigning an associated protocol based on a protocol queried by the session handler to establish a logical connection with the security device.
authenticating the one or more clients trying to gain access to one or more security devices to perform a session.

44. The computer-readable medium of claim 40, wherein transmitting and receiving the data comprises:
data transfer activities selected from the group consisting of downloading data from the communication platform to the one or more security devices, uploading data from the one or more security devices to the communication platform, and receiving status messages from the one or more security devices upon request by the communication platform.

45. A computer system to perform data transfer operations between a remotely located communication module and one or more security devices in a COM-based computer network system having one or more clients, comprising:
a processor;
an output device; and
a storage device to store instructions that are executable by the processor to perform data transfer operations between the remotely located communication module and the one or more security devices in a COM-based computer network system having one or more clients, comprising:
receiving authenticating parameters from the one or more clients trying to gain access to the one or more security devices to perform a session;
generating a unique client identification based on client-entered authenticating parameters for each of the one or more clients for the session;
generating a session handler for each generated unique client identification based on a type of transmission media used by the client to gain access to the security device;
establishing a physical connection between the client and the associated security device for each generated session handler;
establishing a logical connection between the client and the associated security device based on the generated session handler for each generated session handler, upon a successful completion of the physical connection with the associated security device; and
performing data transfer operations substantially simultaneously between the one or more clients and the associated one or more security devices, upon successful completion of the physical and logical connections between the one or more clients and the associated one or more security devices.

46. The system of claim 45, wherein generating the session handler for each generated unique client identification further comprises:
generating the session handler to perform routine data transfer operations between a client and an associated security device, when initiated by the communication platform; and
generating the session handler to perform data transfer operations between the one or more security devices and the communication platform, when required by the one or more security devices to send status messages to the communication platform.

47. The system of claim 45, wherein establishing the physical connection comprises:
establishing physical connections between the one or more clients and the associated one or more security devices and the transmission mediums for each of the session handlers, upon successful completion of the authentication.

48. The system of claim 45, wherein establishing a logical connection comprises:
assigning an associated protocol based on a protocol queried by the session handler to establish a logical connection with the security device.
authenticating the one or more clients trying to gain access to one or more security devices to perform a session.
